(19) United States
(12) Patent Application Publication
(10) Pub. No.: US 2007/0214026 A1
(43) Pub. Date: Sep. 13, 2007

(54) LOGISTICS SYSTEM AND METHOD

(75) Inventors: Kung-Chieh Cheng, Shenzhen (CN); Hong-Qun Liu, Shenzhen (CN)

Correspondence Address: NORTH AMERICA INTELLECTUAL PROPERTY CORPORATION, P.O. BOX 506, MERRIFIELD, VA, 22116, US

(73) Assignee: HON HAI PRECISION INDUSTRY CO., LTD., Taipei Hsien (TW)

(21) Appl. No.: 11/612,482

(22) Filed: Dec. 19, 2006

(30) Foreign Application Priority Data
Mar. 10, 2006 (CN) 200610034350.5

(51) Int. Cl. G06F 9/44

(52) U.S. Cl. 705/7

(57) ABSTRACT

A logistics system is used for automatically making a budget for freights delivery. The logistics system comprises an input module for inputting freights information, departure terminal information, destination terminal information and/or commands for querying and/or modifying data stored in said logistics system, a data module for storing basic logistics data and rate data, a processing module for updating the basic logistics data and the rate data based on said modifying commands, and generating at least one logistics strategy based on the querying commands, and an output module for outputting the logistics strategy. A logistics method for automatically making a budget for freights delivery is also disclosed.

### BACKGROUND OF THE INVENTION

1. Field of the Invention

The present invention generally relates to logistics systems and methods, and more particularly to a system and method for making an optimized logistics strategy.

2. Description of Related Art

As markets move towards globalization, logistics gains more importance in an enterprise's supply chain and products delivery. Different logistics services help product senders deliver freights to product purchasers. Logistics service providers may use many kinds of transportations such as trucks, trains, ships, or aircrafts to deliver the freights.

Generally, different logistics service providers may have different service rates. Furthermore, different transportations may have different logistics charges. The product senders would preferably make relatively optimal logistics strategies for their freights. In general, the logistics service providers may publicize their rates on their websites, or directly send rate lists in paper to the product senders. The product senders may choose an optimum one which has a best rate and a best qualified transportation from different logistics service providers. Then, a logistics strategy for a freights delivery is made by manual. The logistics strategy may include shipper's basic information, shipper's rate and a budget for the freights delivery. When the freights delivery is accomplished by the shipper, check out reports would usually be made for actual logistics costs.

However, this kind of operation suffers badly from low efficiency and too much manual participation. Logistics costs usually cannot be calculated in time, and to make a choice from lots of logistics service providers remains a hard problem.

Therefore, a logistics system and method are needed in the industry to automatically make a logistics budget.

### SUMMARY OF THE INVENTION

A logistics system is used for automatically making a budget for freights delivery. A logistics system comprises an input module, a data module, a processing module, and an output module. The input module is used for inputting freights information, departure terminal information, destination terminal information and/or commands for querying and/or modifying data stored in the logistics system. The data module is used for storing basic information and rate data. The processing module is used for updating the basic information and the rate data based on the inputted commands, and for generating at least one logistics strategy based on the inputted commands. The output module is used for outputting the logistics strategy.

A logistics method comprising the steps of: getting freights information; getting a departure terminal and a destination terminal; judging whether there are any search options inputted; generating all possible logistics strategies that satisfies the search options based on said freights information and said departure terminal and said destination terminal if there are any search options inputted; and outputting said generated logistics strategies.

Other systems, methods, features, and advantages of the present logistics system and method will be or become apparent to one with skill in the art upon examination of the following drawings and detailed description. It is intended that all such additional systems, methods, features, and advantages be included within this description, be within the scope of the present system and method, and be protected by the accompanying claims.

### BRIEF DESCRIPTION OF THE DRAWINGS

Many aspects of the present logistics system and method can be better understood with reference to the following drawings. The components in the drawings are not necessarily to scale, emphasis instead being placed upon clearly illustrating the principles of the inventive system and method. Moreover, in the drawings, like reference numerals designate corresponding parts throughout the several views.

FIG. 1 is a block diagram of a system environment incorporating a logistics system in accordance with an exemplary embodiment;

FIG. 2 is a block diagram of the logistics system of FIG. 1 in accordance with an exemplary embodiment, the logistics system including a first database and a second database;

FIG. 3 is a schematic diagram showing the first database of the logistics system of FIG. 2;

FIG. 4 is a schematic diagram showing the second database of the logistics system of FIG. 2;

FIG. 5 is a flow chart of a logistics method in accordance with an exemplary embodiment;

FIG. 6 is a detailed flow chart showing a logistics strategy generation procedure of the logistics method of FIG. 5 in accordance with a first exemplary embodiment;

FIG. 7 is a detailed flow chart showing a logistics strategy generation procedure of the logistics method of FIG. 5 in accordance with a second exemplary embodiment;

FIG. 8 is a detailed flow chart showing a logistics strategy generation procedure of the logistics method of FIG. 5 in accordance with a third exemplary embodiment; and

FIG. 9 is a detailed flow chart showing a logistics strategy generation procedure of the logistics method of FIG. 5 in accordance with a fourth exemplary embodiment.

### DETAILED DESCRIPTION OF THE INVENTION

Reference will now be made to the drawings to describe a preferred embodiment of the present logistics system and preferred embodiments of the present logistics method.

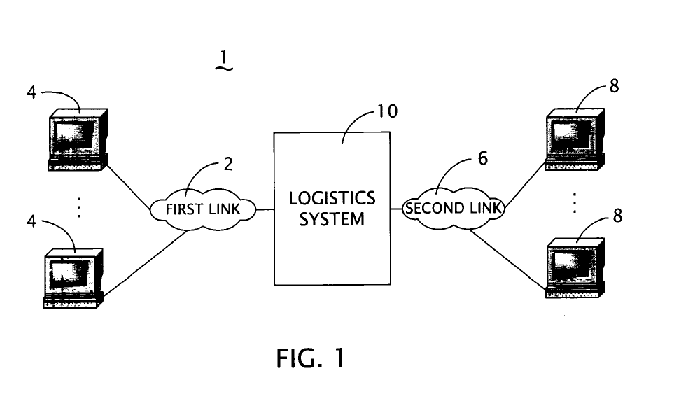

Referring to FIG. 1, a schematic view shows a system environment 1 incorporating a logistics system 10 in accordance with an exemplary embodiment. In the system environment 1, the logistics system 10 is connected to a plurality of shipper computer terminals 4 via a first link 2, and a plurality of sender computer terminals 8 via a second link 6. The first link 2 may be an extranet, and the second link 6 may be an intranet.

The shipper computer terminals 4 are used for the shippers to input basic information of the shippers. The basic information may include names, addresses, contact information (e.g. telephone numbers), representatives, and general introductions, etc. And the shipper computer terminals 4 are also used for the shippers to send first commands for adding/modifying/querying/deleting the basic information and rates of services.

The sender computer terminals 8 are used for the product senders to input freights information. The freights information may include weights of the freights, volumes of the freights, departure terminals, destination terminals, and allowable transportations, etc. The logistics system 10 generates at least one logistics strategy according to the freights information. Furthermore, the sender computer terminals 8 can also be used for the product senders to send second commands for adding/modifying/querying/deleting freights information, and/or shipper's basic information, for example, to add a new shipper, to delete a particular shipper, to modify the basic information, and so on.

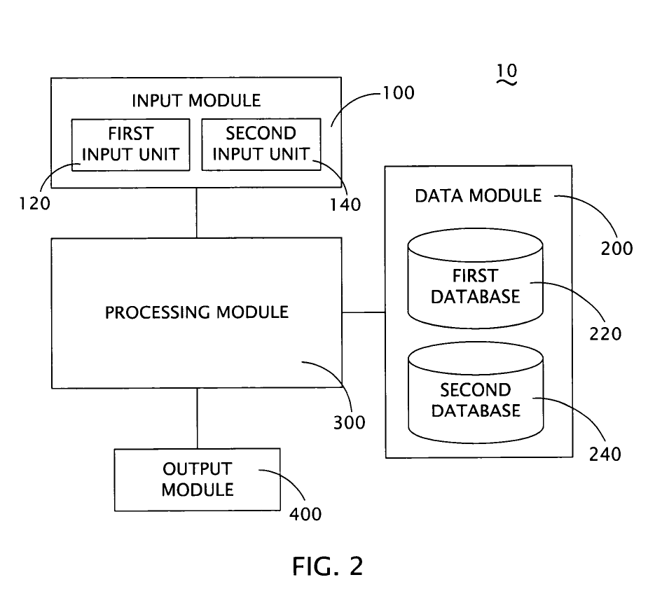

Referring to FIG. 2, the logistics system 10 includes an input module 100, a data module 200, a processing module 300, and an output module 400.

The input module 100 includes a first input unit 120 and a second input unit 140. The first input unit 120 is used for receiving the shipper's basic information and the first commands from the shipper computer terminals 4. The second input unit 140 is used for receiving the freight information and the second commands from the sender computer terminals 8.

The data module 200 includes a first database 220 and a second database 240. The first database 220 is used for storing the shipper's basic information, the freights information, etc. The second database 240 is used for storing the rates of services.

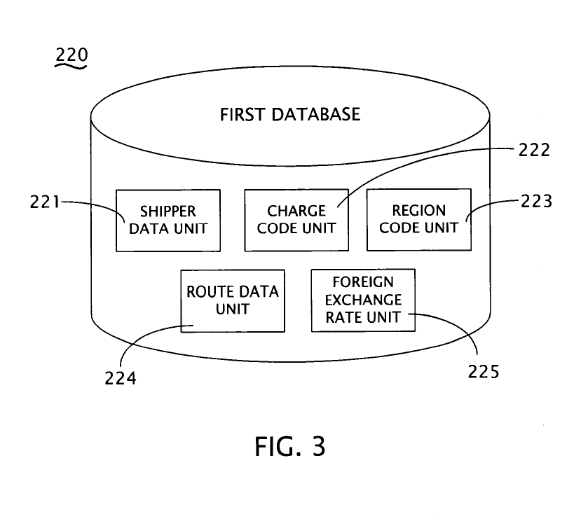

Referring also to FIG. 3, the first database 220 includes a shipper data unit 221, a charge code unit 222, a region code unit 223, a route data unit 224, and a foreign exchange rate unit 225.

The shipper data unit 221 is used for storing the shipper's basic information. The charge code unit 222 is used for storing names and codes for delivery charges that are possibly generated during freight delivery. Such delivery charges may include cargo handling charges, commission charges, customs clearing charges, insurance charges, etc. The region code unit 223 is used for storing codes and names of countries at different categorized regions. For example, Australia and New Zealand are often categorized in a region called Oceania. The route data unit 224 is used for storing routes information. Such routes information may include names and codes of departure terminals, names and codes of destination terminals, delivery distances between the departure terminals and the destination terminals, distances that the departure terminals or the destination terminals are away from nearby airports or harbors, etc. The Foreign exchange rate unit 225 is used for storing foreign exchange rates. For example, different shippers may list the rates with different currencies according to accepted currency payments, generally it is necessary to convert the rates with different currencies to a standardize currency such as the US dollar, for comparing the rates of different shippers.

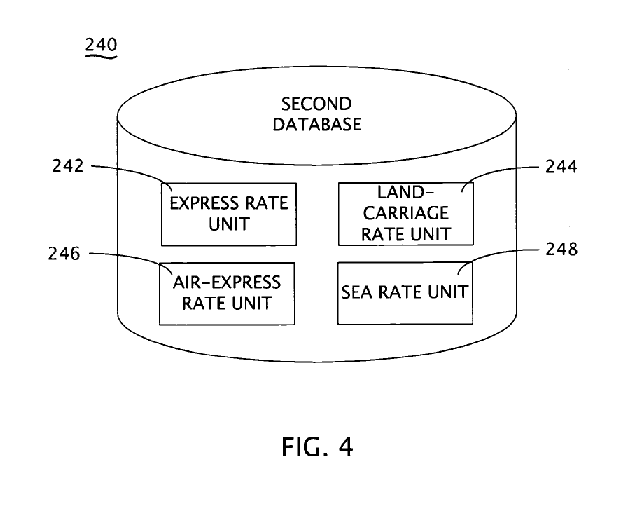

Referring to FIG. 4, the second database 240 includes an express rate unit 242, a land-carriage rate unit 244, an air-express rate unit 246, and a sea rate unit 248.

The express rate unit 242 is used for storing express delivery rates. In the express delivery unit 242, various delivery costs are listed corresponding to both amount/weight of the freights to be delivered and the delivery distance. For example, a flat charge is needed for an initial weight of the freights, e.g. 500 g, and an additional charge is needed for additional weight of the freights.

Similarly, the land-carriage rate unit 244, the air-express rate unit 246, and the sea rate unit 248 are respectively used for storing the rates on land-carriage, air-freight, and sea transportations.

The processing module 300 as shown in FIG. 2 is used for processing the data stored in the data module 200 based on the commands or information inputted from the input module 100, and querying data to generate logistics strategies and reports. That is, the processing module 300 can modify data stored in the data module 200, such as in the express rate unit 242, according to the commands from the shipper computer terminals 4 and/or the sender computer terminals 8. On the other hand, when second commands inputted from one of the sender computer terminals 8 to the processing module 300 are data querying commands, the process module 300 executes the data querying commands in the data module 200, and generates reports that list all qualified logistics strategies including all related shippers and information thereof.

The output module 400 as shown in FIG. 2 is used for outputting the strategies and reports produced by the processing module 300 to the sender computer terminals 8 via the second link 6. Therefore, an optimum logistics strategy can be chosen.

One example showing how the logistics system 10 works will be described hereinafter. The first command inputted by a shipper from the shipper computer terminal 4 is a data modifying command for modifying this shipper's basic information stored in the shipper data unit 221. The data modifying command is transmitted to the processing module 300 via the first link 2 and the first input unit 120. The processing module 300 executes the data modifying command to update the shipper's basic information. Thus, the data stored in the data module 200 is kept updated. As such, the product sender can make a logistics strategy for the freights based on the updated data.

A second example showing how the logistics system 10 works will be described hereinafter. A piece of freights information and a second command is sent to the processing module 300, via the second input unit 140. The second command inputted is a logistics strategy generating command. Other second commands may be sent via the second input unit 140, specifying one or more allowable transportations, such as land-carriage, air-express, etc. According to the logistics strategy generating command, the processing module 300 queries in the data module 200 for qualified shippers based on the first freights information. A list for all qualified logistics strategies of the freights will be generated, and outputted to the sender computer terminal 8 via the second link 6. The logistics strategies include the basic information of the qualified shippers and their respective rates. After processing the outputted list, such as ordering by the rates, a most suitable shipper would be chosen to carry out this delivery (hereinafter the shipper that is chosen to carry out this delivery is called chosen shipper). A second command may still be sent by the product sender from the sender computer terminal 8 via the second link 6. The inputted second command is a service request command, for instructing the processing module 300 to generate a service request order for informing the chosen shipper of the freights delivery. Then, the output module 400 will send the service request order to the shipper computer terminal 4 through the first link 2. Such order includes the freights information and the delivering time, etc.

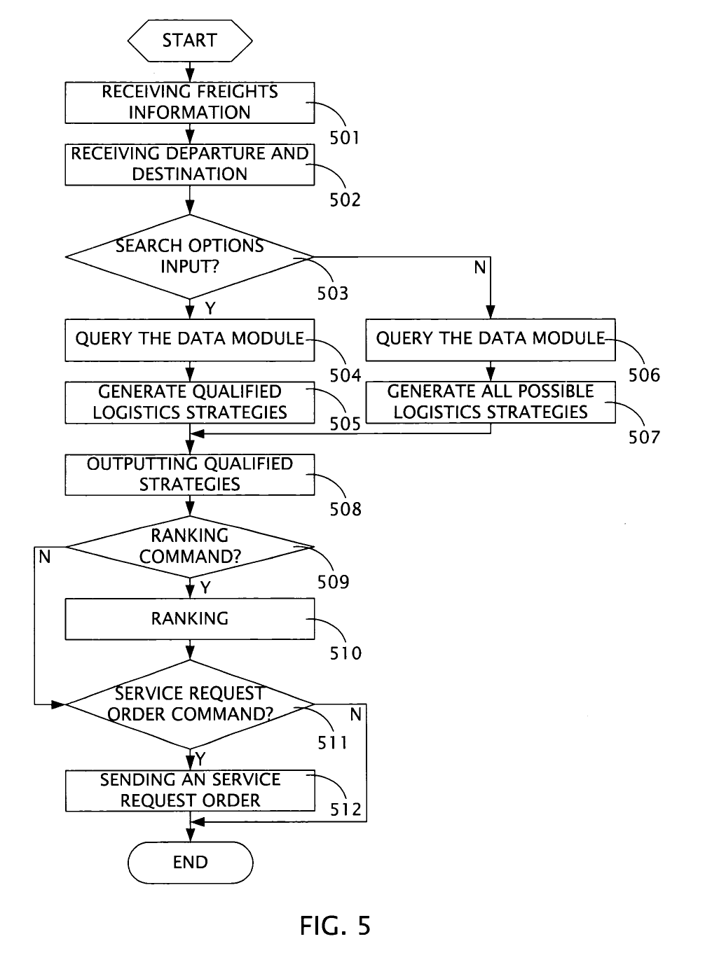

Referring to FIG. 5, a logistics method utilizing the logistics system 10 is illustrated. First, in step 501, the logistics system 10 receives freights information from the input module 100. Such freights information may include weights of the freights, volumes of the freights, and other necessary information, such as frangibility or moistureproof of the freights to be delivered, etc.

Second, in step 502, the logistics system 10 receives route information from the input module 100. The processing module 300 may then query the route data unit 224, and the delivery distance using different transportations may be obtained.

Third, in step 503, search option are received from the sender computer terminals 8, if needed. For example, the product sender may send second commands specifying one or more transportations. Particular shippers may be specified as well.

If it is concluded in step 503 that there is some search option, the processing module 300 queries the data module 200 based on the freight information, the route information, and the search options that has been inputted (step 504).

Next, in step 505, generate a list of all qualified logistics strategies that satisfy the search option.

An example showing the querying and generation of an optimized logistics strategy when the search option specifying delivery on air-express will be described hereinafter. The product sender inputs a second command from the sender computer terminal 8 specifying that an air-express transportation should be used for delivery. The processing module 300 queries the shipper data unit 221 for all shippers that are qualified to deliver freights using air-express transportation. The processing module 300 also queries the air-express rate unit 246 for the chosen shippers' corresponding rates. Then the processing module 300 processes the data that has been inputted and queried, such as, calculating logistics costs based on the freights information and the delivery distance, etc. Similarly, more limitations may be inputted for more definite query results. For instance, if the freights are dangerous, a qualified shipper should be eligible for delivering dangerous freights, or even have a qualified dangerous delivering license.

If it is concluded in step 503 that there is no search option inputted, the processing module 300 queries the data module 200 based on the inputted freights information, route information without any search option (step 506).

All available logistics strategies are generated and listed out (step 507). Such strategies may include information on the transportations, the shippers and their corresponding rates, and so on.

After that, the output module 400 outputs the logistics strategies (step 508). The output module 400 may output the logistics strategies via the sender computer terminal 8 in the form like displaying on a screen or printing out, to provide a reference for the product sender.

Step 509, the processing module 300 detects if there are any ranking commands been inputted, for example, ranking the logistics strategies in the order of their rates.

If it is concluded in step 509 that there is a ranking command been inputted, the logistics strategies are ranked based on the inputted command (step 510), and then step 511 as described below will be executed.

If it is concluded in step 509 that there aren't any ranking commands been inputted, or a ranking has been executed, the processing module 300 detects if there is a service request command been inputted (step 511).

If in step 511, a service request command is detected, the processing module 300 generates a service request order and sends the generated order via the output module 400 to a shipper computer terminal 4 relative to the chosen shipper (step 512). Such order may include the freights information, the delivery distances, the delivering time, etc. Thus the chosen shipper is informed to carry out the delivery and the flow of the logistics method comes to an end. If in step 511, no order-sending command has been detected, the logistics method directly comes to the end.

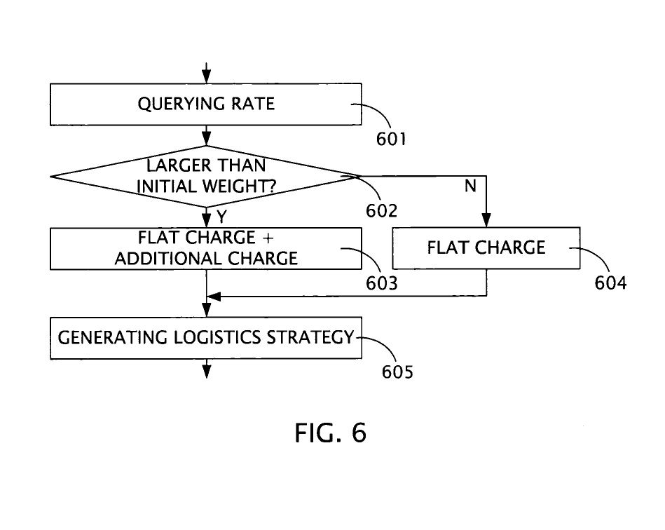

Referring now to FIG. 6, a detailed flow chart of step 505 in FIG. 5 is shown in accordance with a first exemplary embodiment of the logistics method when the search option in step 503 specifies that the transportation to be used for delivery is express.

The processing module 300 queries in the second database 240 for the rates provided by the express shippers (step 601). To be more definitely, the query is carried in the express rate unit 242. Thus, all the rates from all the express shippers are obtained.

Step 602, a comparison between the weight of the freights to be delivered and an initial weight given by the express shippers is made.

If the weight of the freights is greater than the initial weight, the express charge will be a sum of an flat charge and an additional charge (step 603). For example, if the flat charge is US$25 for freights within an initial weight, preferably 500 grams, and for each extra 100 grams, an additional charge of US$4 should be paid. If the freights to be delivered weigh 800 grams, the express charge would be US$25+(800 g−500 g)/100 g*US$4=US $37.

If the weight of the freights is less than or equal to the initial weight, the express charge would only include the flat charge (step 604). As the example described in step 603, if the freights to be delivered weigh 480 grams, the express charge would just be US$25.

After the express charges are calculated either in step 603 or in step 604, all possible logistics strategies are generated based on the express charge corresponding to each express shipper (step 605).

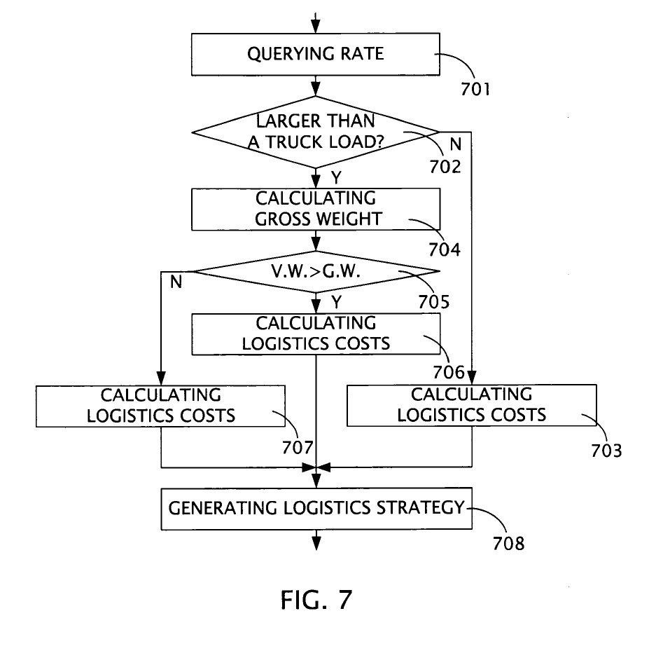

Referring now to FIG. 7, a detailed flow chart of step 505 in FIG. 5 is shown in accordance with a second exemplary embodiment of the logistics method when the search option in step 503 specifies that the transportation to be used for delivery is land-carriage.

The processing module 300 queries the land-carriage rate unit 244 for all qualified land-carriage shippers and their rates (step 701).

Next, in step 702, a comparison between the weight of the freights to be delivered and a load of a single truck or a train wagon is made.

If the weight of the freights is less than or equal to the load of a single truck or a train wagon, a carriage charge will be a flat charge. Here, flat charge means a charge for a single truck or a train wagon. Some extra charges may be added, such as a parking charge for the trucks (step 703).

If the weight of the freights is greater than the load of a single truck or a train wagon, a volume weight calculation of the freights will be made (step 704). The volume weight is calculated as follows: Volume Weight=Volume*C, wherein C is a constant value. An example is that if the freights have a volume of 1 cubic meter, its volume weight would preferably be 167 kilograms.

A comparison between the volume weight and a gross weight of the freights is made in step 705.

If the volume weight is greater than the gross weight, the carriage charge will be the volume weight multiplied by the rate price per volume weight unit given by the shippers (step 706).

Contrarily, if the gross weight is greater than the volume weight, the carriage charge will be the gross weight multiplied by the rate price for each gross weight unit given by the shippers (step 707).

After the carriage charges for all qualified shippers are calculated either in step 703, step 706 or step 707, logistics strategies are generated based on the land-carriage logistics costs corresponding to each land-carriage shippers (step 708).

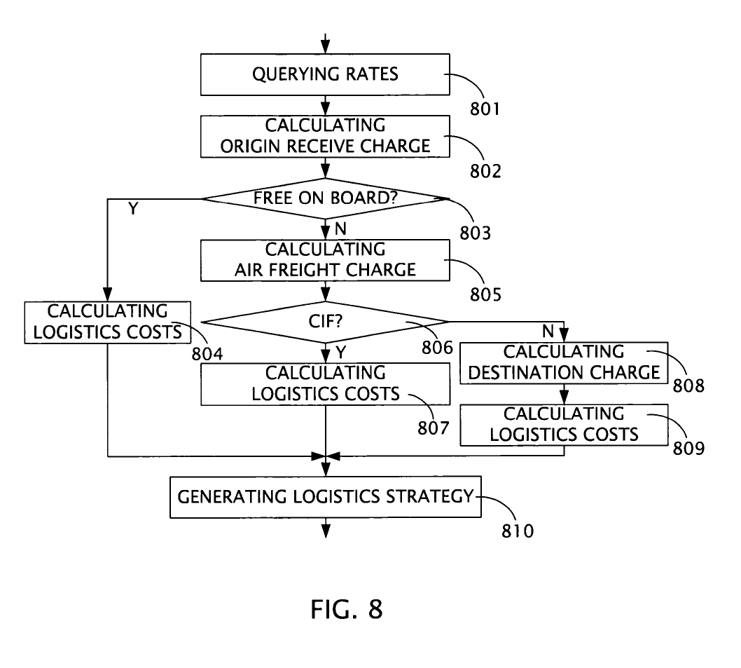

Referring now to FIG. 8, a detailed flow chart of step 505 in FIG. 5 is shown in accordance with a third exemplary embodiment of the logistics method when the search option in step 503 specifies that the transportation to be used for delivery is air-express.

The processing module 300 queries in the air-express rate unit 246 for the rates given by the air-express shipper (step 801). Thus, all the rates from qualified air-express shippers are obtained.

Next, in step 802, the processing module 300 calculates origin receive charges (ORC) for the freights to be delivered. The ORC includes the container freight station charges, document charges, cargo handling charges and commission charges, etc.

In step 803, the processing module 300 judges whether delivery of the freights are charged by “free on board” (FOB). Generally, FOB refers to that all costs generated after the aircraft takes off will be due to a consignee.

If it is concluded in step 803 that delivery of the freights are charged by FOB, the air-express logistics cost will be a sum of cartages and the ORC (step 804). Here, the cartage means a charge for transporting the freights from the product sender's warehouses to predetermined airports, such cartages will preferably be calculated in a similarly way to the calculation for the carriage charges as described in the second embodiment.

If it is concluded in step 803 that delivery of the freights are not charged by FOB, a calculation for an air-freight charge will be made (step 805). The air-freight charge may include a charge for the air-flight based on a volume weight or gross weight as described in the second embodiment, a fuel surcharge, and an insurance fee, etc.

Next, in step 806, the processing module 300 will judge whether delivery of the freights to be delivered are charged by “cost, insurance and freight” (CIF). Generally, CIF (cost, insurance and freight) means that all charges will due to the product sender before the freights are delivered to the consignee.

If it is concluded in step 806 that delivery of the freights are charged by CIF, the air-express logistics cost will be a sum of cartages, ORC and air-freight charges (step 807).

If it is concluded in step 806 that delivery of the freights are not charged by CIF, a destination charge will be calculated in step 808. The destination charge includes custom duties, document charges, cargo handling charges, commission charges, and destination cartages, etc. Here, the destination cartages refer to charges for delivering the freights from destination airports to destination warehouses, which will be calculated similarly to the calculation for the carriage charge as described in the second embodiment.

In step 809, calculating the air-express logistics cost which is a sum of the cartages, the ORC, the air-freight charges and the destination charge.

After the air-express logistics costs for all qualified shippers are calculated either in step 804, step 807 or step 809, logistics strategies are generated based on the air-express logistics costs corresponding to each air-express shippers (step 810)

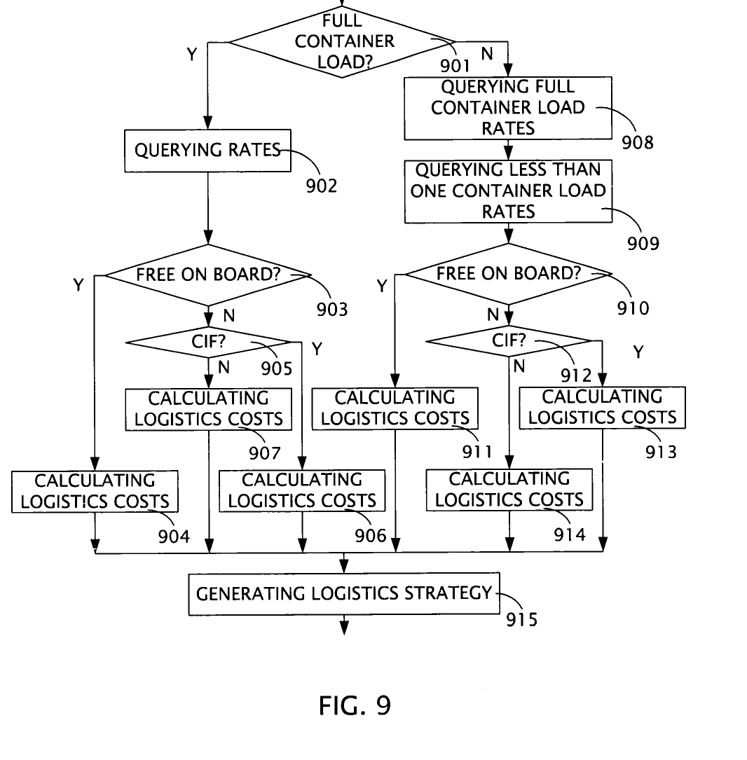

Referring now to FIG. 9, a detailed flow chart of step 505 in FIG. 5 is shown in accordance with a fourth exemplary embodiment of the logistics method when the search option in step 503 specifies that the transportation to be used for delivery is sea.

First, in step 901, the processing module 300 judges whether the freights to be delivered will be loaded by full container load (FCL). Here, FCL means that a container will be loaded with only the freights from this product sender, no other freights from other product senders will be loaded. In the FCL situation, a shipping charge will be accounted on the number of containers, depending on the model and size of the containers.

If it is concluded in step 901 that the freight will be loaded by FCL, the processing module 300 queries the sea rate unit 248 for FCL sea shippers and their corresponding FCL rates (step 902).

Then in step 903, whether delivery of the freights to be delivered will be charged by FOB is judged. Here “FOB” means the same as in the third embodiment.

If it is concluded in step 903 that delivery of the freights to be delivered are charged by FOB, a calculation for the sea logistics costs is similar to the calculation in the FOB situation as described in the third embodiment. The logistics costs would be a sum of cartages and the ORC (step 904).

If it is concluded in step 903 that delivery of the freights are not charged by FOB, whether delivery of the freights are charged by CIF will be judged in step 905 similar to step 806 as described in the third embodiment.

If in step 905 it is concluded that delivery of the freights are charged by CIF, the logistics cost will be a sum of cartages, ORC and shipping charges (step 906).

And if in step 905 it is concluded that delivery of the freights are not charged by CIF, a destination charge will be added to the logistics cost on the basis of calculation in step 906 (step 907). The calculation of the destination charge is similar to that in step 808 as described in the third embodiment.

Now, back to step 901, if the freights to be delivered could not be loaded by FCL, the processing module 300 queries in the sea rate unit 248 for not only the FCL shippers and their relative rates (908), but also less than one container load (LCL) shippers and their relative rates (step 909). Here LCL means that the container will not be loaded with only this kind of freights or the freights from this product sender.

Next in step 910, the processing module 300 judges whether delivery of the freights are charged by FOB as in the step 904.

If it is concluded in step 910 that delivery of the freights are charged by FOB, the calculation for the shipping charge is similar to the calculation in the FOB situation as described in step 905. The logistics cost will be a sum of cartages and the ORC (step 911).

If in step 910 it is concluded that delivery of the freights are not charged by FOB, whether delivery of the freights are charged by CIF is judged in step 912 as described in step 906.

If it is concluded in step 912 that delivery of the freights are charged by CIF, the logistics costs will be a sum of cartages, the ORC and LCL shipping charges (step 913).

If it is concluded in step 912 that delivery of the freights are not charged by CIF, a destination charge will be added to the logistics cost on the basis of the calculation in step 913 (step 914).

After the sea logistics costs for all qualified shippers are calculated either in step 904, step 906, step 907, step 911, step 913 or step 914, logistics strategies are generated based on the sea logistics costs corresponding to each sea shippers (step 915).

Based on the above logistics method, a product sender can acquire all possible logistics strategies not only when there are no limitations inputted, but also when there is a search option, the product sender can get the possible logistics strategies on the basis of the limitations inputted. All accounted logistics strategies could be outputted to the sender computer terminal indicating qualified shippers and the logistics costs for each shipper. Thus a budgeted for the logistics will be made automatically. The product sender can then choose from the generated logistics strategies for a best one, such as a cheapest, to carry out the delivery.

What is claimed is:

1. A logistics method comprising the steps of:
getting freights information;
getting a departure terminal and a destination terminal;
judging whether there are any search options inputted;
generating all possible logistics strategies that satisfies the search options based on said freights information, said departure terminal and said destination terminal if there are any search options inputted; and
outputting said generated logistics strategies.

2. The logistics method as claimed in claim 1, further comprising the steps of:
judging whether there is a ranking command inputted; and
ranking said generated logistics strategies according to said ranking command.

3. The logistics method as claimed in claim 2, further comprising the steps of:
judging whether there is a service request command inputted;
generating a service request order according to said inputted service request command; and
sending said service request order to a corresponding shipper.

4. The logistics method as claimed in claim 1, further comprising the steps of:
querying for qualified express delivery shippers and relative rates if said search option specifies an express delivery.

5. The logistics method as claimed in claim 4, further comprising the steps of:
judging whether a weight of freights to be delivered is greater than an initial weight;
determining an express charge to be a flat charge if said weight of freights to be delivered is less than said initial weight; and
determining said express charge to be a sum of said flat charge and an additional charge counted on each additional weight of said freights to be delivered if said weight of freight to be delivered is larger than said initial weight.

6. The logistics method as claimed in claim 1, further comprising the steps of:
querying for qualified land-carriage delivery shippers and relative rates if said search option specifies a land-carriage delivery.

7. The logistics method as claimed in claim 6, further comprising the steps of:
judging whether a weight of freights to be delivered is larger than a load of a single truck or a single train wagon;
determining a carriage charge to be a charge for a single truck if said weight of freights to be delivered is less than said load of a single truck or a single train wagon.

8. The logistics method as claimed in claim 7, further comprising the steps of:
judging if a volume weight is larger than a gross weight of freights to be delivered if said weight of freights to be delivered is larger than said load of a single truck or a single train wagon;
determining a carriage charge to be said volume weight multiplied by a rate price for each volume weight unit if said volume weight is larger than said gross weight; and
determining a carriage charge to be said gross weight multiplied by a rate price for each gross weight unit if said gross weight is larger than said volume weight.

9. The logistics method as claimed in claim 1, further comprising the steps of:
querying for qualified air-express delivery shippers and relative rates if said search option specifies an air-express delivery; and
calculating origin receive charges;
judging whether delivery of said freights to be delivered is charged by free on board; and
determining an air-express logistics cost to be a sum of cartages and said origin receive charges if delivery of said freights to be delivered is charged by free on board.

10. The logistics method as claimed in claim 9, further comprising the steps of:
calculating an air-freight charge when delivery of said freights to be delivered are not charged by free on board;
judging whether delivery of said freights is charged by cost, insurance and freight;
determining an air-express logistics cost to be a sum of said cartages, said origin receive charges and said air-freight charge if delivery of said freights is charged by cost, insurance and freight.

11. The logistics method as claimed in claim 10, further comprising the steps of:
calculating a destination charge;
determining an air-express logistics cost to be a sum of said cartages, said origin receive charge, said air-freight charges and said destination charges if delivery of said freights to be delivered is not charged by cost, insurance and freight.

12. The logistics method as claimed in claim 1, further comprising the steps of:
judging whether said freights to be delivered are loaded by full container load if said search option specifies a sea delivery;
querying for qualified full container load sea shippers and relative rates if said freights to be delivered are loaded by full container load.

13. The logistics method as claimed in claim 12, further comprising the steps of:
judging whether delivery of said freights is charged by free on board;
determining a sea logistics cost to be a sum of cartages and origin receive charge if delivery of said freights is charged by free on board; and
judging whether delivery of said freights is charged by cost, insurance and freight if delivery of said freights is not charged by free on board.

14. The logistics method as claimed in claim 13, further comprising the steps of:
determining a sea logistics cost to be a sum of cartages, origin receive charges and shipping charges if delivery of said freights is charged by cost, insurance and freight;
calculating a destination charge when delivery of said freight is not charged by cost, insurance and freight; and
determining a sea logistics cost to be a sum of cartages, origin receive charges, a shipping charge and said destination charges if delivery of said freights is not charged by cost, insurance and freight.

15. The logistics method as claimed in claim 12, further comprising the steps of:
querying for qualified less than one container load sea shippers and relative rates if said freights to be delivered are not loaded by full container load;
judging whether delivery of said freights to be delivered is charged by free on board;
determining a sea logistics cost to be a sum of cartages and origin receive charges if delivery of said freights to be delivered is charged by free on board; and
judging whether delivery of said freights to be delivered is charged by cost, insurance and freight if delivery of said freights to be delivered is not charged by free on board.

16. The logistics method as claimed in claim 15, further comprising the steps of:
determining a sea logistics cost to be a sum of cartages, origin receive charges and less than one container load shipping charges if delivery of said freights to be delivered is charged by cost, insurance and freight; and
determining a sea logistics cost to be a sum of cartages, origin receive charges, less than one container load shipping charges and destination charges if delivery of said freights to be delivered is not charged by cost, insurance and freight.

17. A logistics system comprising:
an input module for inputting freights information, departure terminal information, destination terminal information and/or commands for querying and/or modifying data stored in said logistics system;
a data module for storing basic information and rate data;
a processing module for updating said basic information and said rate data based on said modifying commands, and for generating at least one logistics strategy based on said querying commands; and
an output module for outputting said logistics strategy.

18. The logistics system as claimed in claim 17, wherein said input module comprises:
a first input unit for receiving data and/or first commands from shippers' terminals; and
a second input unit for receiving data and/or second commands from product senders' terminals.

19. The logistics system as claimed in claim 17, wherein said data module comprises:
a first database which comprises:
a shipper data unit for storing basic information on shippers;
a charge code unit for storing information on fees and/or charges for freights delivery; and
a route data unit for storing information on departure terminals and destination terminals.

20. The logistics system as claimed in claim 19, wherein said data module further comprises:
a second database which comprises:
an express rate unit for storing rates for express deliveries;
a land-carriage rate unit for storing rates for land-carriage deliveries;
an air-express rate unit for storing rates for air-express deliveries; and
an sea rate unit for storing rates for sea deliveries.
